(19) United States
(12) Patent Application Publication
(10) Pub. No.: US 2006/0145397 A1
(43) Pub. Date: Jul. 6, 2006

(54) Method and tool for molding

(76) Inventors: Frederick G. Steil, Lake Orion, MI (US); Lawrence J. Navarre, Metamora, MI (US); Ying Huang, Windsor (CA); Charles P. Azzopardi, Livonia, MI (US)

Correspondence Address: MILACRON INC., 2090 FLORENCE AVE., CINCINNATI, OH, 45206, US

(21) Appl. No.: 11/029,432

(22) Filed: Jan. 5, 2005

(51) Int. Cl. B29C 45/73; B29C 45/40

(52) U.S. Cl. 264/328.16; 425/542; 264/334

(57) ABSTRACT

A molding tool comprises a mold component having a body, a molding surface thereon, and at least one passage internal to the body for conducting a heat transfer fluid from an inlet thereto to an outlet therefrom, the passage comprising a roof spaced from and located proximate the molding surface, a floor spaced from the roof and located farther from the molding surface than the roof, the roof and floor being joined to define a passage cross section, wherein the roof extends within the tooling body so as to substantially conform in size and shape to one or more contours of the molding surface and at least one of the area of the passage cross section and the offset distance of the passage from the molding surface varies between the inlet and outlet. Advantageously, the passage comprises at least one support pillar to constrain deflection of the molding surface during molding.

### BACKGROUND OF THE INVENTION

1. Field of the Invention

This invention relates generally to tools for molding. In particular, this invention relates to metal tools for molding having internal passages for conducting a heat transfer fluid within the interior of the tool.

2. Description of Related Art

In methods of molding to which the present invention pertains, molding material in a flowable conditioned is conformed to molding surfaces defined by a molding tool, conditioned to be sufficiently solid to be self supporting without unacceptable deformation and removed from the molding tool, typically with separation of components of the tool. Such methods are used to mold materials which are conditioned to be flowable, such as by working and heating, and are solidified by removal of heat, as well as materials which are flowable at room temperature and cured to a solid by chemical or physical processes or a combination thereof. In blow molding processes, the flowable molding material has the form of a tubular preform or parison that is expanded within molding tool cavities by introduction of a pressurized fluid. On cooling, the molding material is sufficiently solid to retain the expanded shape. In die casting and injection molding processes, cavities of a molding tool are filled with flowable molding material, known as “melt”, and held therein under pressure until the molding material is solidified by transfer of heat therefrom. Injection molding processes may include injection of pressurized fluid in selected locations of the mold cavities during or after mold filling to create articles having internal voids.

In these molding processes, rates of heat transfer from the flowable material directly affect the conformance thereof to the molding surfaces of the cavities and solidification of material prior to separation of the mold components. In blow molding, expansion of the parison is generally controlled as a function of pressure of the expansion fluid, the force required to expand the parison being affected by the resistance of the material to stretch and the area to which the expansion fluid is applied (area increases with expansion of the parison). As heat is transferred from the material of the parison, resistance to stretch increases and the force required to continue expansion increases. Should the rate of heat transfer be too great, incomplete expansion may result. In injection molding, filling of cavities is generally controlled as a function of melt pressure during injection, melt pressure being affected by the viscosity of the melt, the rate of flow of the melt and the force applied to inject melt. As heat is transferred from the melt, the melt's resistance to flow increases, the force required to inject melt at the same rate of flow increases, and melt pressure increases. Should the rate of heat transfer be too great, solidification of material will result in increased pressure in the melt increasing stress on mechanical components and may prevent complete filling of the mold cavities. Solidification of the expanded article in blow molding and melt after mold filling in injection molding is primarily affected by the thermal mass of material within the mold cavities and the effectiveness of heat transfer from the material. In general, the time allotted in a molding process to transfer sufficient heat from the molded material to achieve adequate solidification to avoid unacceptable deformation on removal of the molded article from the mold is confirmed empirically for a particular molding tool on a particular molding machine. Should conditions decrease the effective rate of heat transfer during this segment of the molding process, separation of mold components in accordance with a predetermined time for material solidification may result in inelastic deformation of the molded article. Hence, rates of heat transfer directly affect the quality of molded articles produced by a molding process.

In the aforesaid methods of molding, it is known to circulate heat transfer fluid through the molding tool to enhance control over transfer of heat from the molding material therein. It is known to provide passages for conduction of the heat transfer fluid within the molding tool and to have the passages follow paths that effectively distribute heat transfer fluid flow among plural paths proximate the molding surface. Such passages are often produced by machining and hence have substantially uniform cross sections, such as are produced by drilling and milling. Density of such heat transfer fluid passages is constrained by machining costs and the need to insure limited flex of the molding surface during molding. In general, machining of passages produces irregular patterns of heat transfer according to the volume of tool body that is served by the heat transfer fluid passages and the effective offset distance of heat transfer fluid passages from the molding surface. Production of molding tools by sequential deposition has allowed creation of tools having complex passages for conduction of heat transfer fluids within the tooling component interior. With such methods, it is known to provide passages of uniform cross section paralleling at least a portion of the molding surface. In a particular application of such methods, finned passages of rectangular cross section are created wherein the fins define plural parallel channels terminating in common inlet and outlet passages. While the passages known in such methods overcome certain of the inherent deficiencies of passages realizable from machining, the nature of such known passages nevertheless produce lines of temperature difference on the molding surface associated with characteristics of the passages. Hence, there remains a need for improved constructions of internal heat transfer passages for tools for molding.

### SUMMARY OF THE INVENTION

It is an object of the present invention to provide a molding tool having a heat transfer passage conforming substantially to at least one contour of a molding surface and wherein at least one of the area of the passage cross section and the offset distance of the passage from a molding surface varies between the passage inlet and passage outlet.

It is a further object of the present invention to provide a molding tool comprising a mold component having a tool body, a molding surface thereon, and at least one internal passage for conducting a heat transfer fluid from an inlet thereto to an outlet therefrom, the passage comprising a roof spaced from and located proximate to the molding surface, a floor spaced from the roof and located farther from the molding surface than the roof, the roof and floor being joined to define a passage cross section, wherein the roof extends within the tooling body so as to substantially conform in size and shape to one or more contours of the molding surface and at least one of the area of the passage cross section and offset distance of the passage from the molding surface varies between the passage inlet and passage outlet.

It is a still further object of the present invention to provide a molding tool comprising a mold component having a tool body, a molding surface thereon, and at least one internal passage for conducting a heat transfer fluid from an inlet thereto to an outlet therefrom, the passage comprising a roof spaced from and located proximate to the molding surface, a floor spaced from the roof and located farther from the molding surface than the roof, the roof and floor being joined to define a passage cross section, and at least one internal support pillar between the roof and floor, wherein at least one of the area of the passage cross section and the offset distance of the passage from the molding surface varies between the inlet and the outlet.

It is a still further object of the present invention to provide a method of molding an article the method comprising forcing flowable material to conform to molding surfaces of a mold cavity defined by components of a molding tool, heat is transferred from the flowable material to cause solidification thereof, and the components of the molding tool are separated to permit removal of the molded article, wherein the molding tool comprises at least one mold component having a body, a molding surface thereon, and at least one passage internal to the body for conducting a heat transfer fluid from an inlet thereto to an outlet therefrom, wherein the passage comprises a roof spaced from and located proximate to the molding surface, a floor spaced from the roof and located farther from the molding surface than the roof, the roof and floor being joined to define a passage cross section and wherein the roof extends within the mold body so as to substantially conform in size and shape to one or more contours of the molding surface and at least one of the area of the passage cross section and offset distance of the passage from the molding surface varies between the passage inlet and passage outlet.

Further objects and advantages of the invention shall be made apparent from the accompanying drawings and the following description thereof.

In accordance with the aforesaid objects a molding tool of the present invention comprises a mold component having a body, a molding surface thereon, and at least one passage internal to the body for conducting a heat transfer fluid from an inlet thereto to an outlet therefrom, the passage comprising a roof spaced from and located proximate to the molding surface, a floor spaced from the roof and located farther from the molding surface than the roof, the roof and floor being joined to define a passage cross section, wherein the roof extends within the molding tool body so as to substantially conform in size and shape to one or more contours of the molding surface and at least one of the area of the passage cross section and the offset distance of the passage from the molding surface varies between the inlet and the outlet. Further, the passage advantageously comprises at least one internal feature for inducing turbulent flow of the heat transfer fluid. Still further, the passage advantageously comprises at least one support pillar, the support pillars effective to provide support to the molding surface so as to sufficiently limit deflection thereof during molding to produce molded articles of acceptable quality.

### BRIEF DESCRIPTION OF THE DRAWINGS

FIG. 1 is a three dimensional view of a molding tool in accordance with the invention.

FIGS. 2a and 2b are cross sectional views of portions of components of the molding tool of FIG. 1.

FIG. 3 is a top view of a partial section of the portion of the molding tool of FIG. 2b illustrating locations of support pillars within the internal passage.

FIG. 4 is a cross sectional view of a portion of an internal passage illustrating passage height variation.

### DETAILED DESCRIPTION OF THE PREFERRED EMBODIMENT

The invention shall be illustrated with reference to a preferred embodiment which shall be described in detail. It is not the intention of applicants that the invention be limited to the preferred embodiment, but rather that the invention shall be defined by the appended claims and all equivalents thereof.

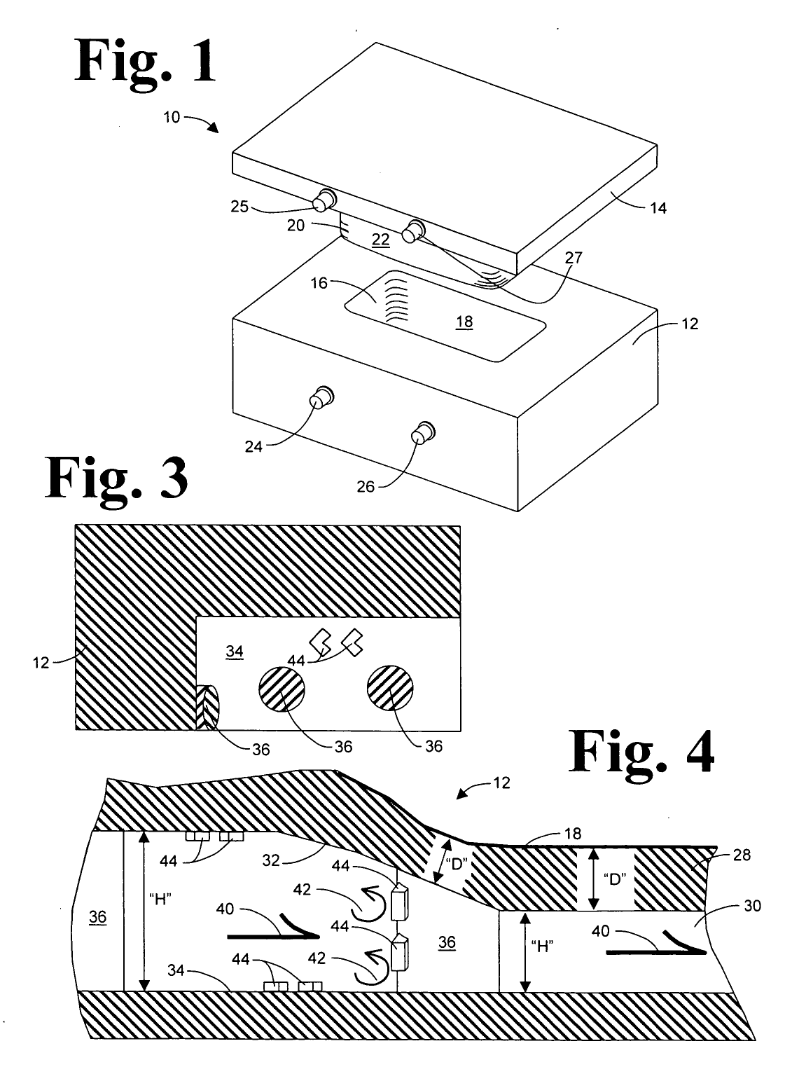

Referring to FIG. 1, a molding tool 10 for injection molding has mating mold components comprising cavity component 12 and core component 14. Cavity component 12 has at least one recess therein such as recess 16 with surface 18 defining a first molding surface for shaping material to be molded. Core component 14 has at least one core element 20 thereon with surface 22 defining a second molding surface for shaping material to be molded. With mating components 12 and 14 mated together, a gap exists between core element 20 and recess 16 defining a cavity. The cavity defines the shape and size of an article to be molded therein, while the molding surfaces 18 and 22 determine the surface features of the molded article. Connections such as inlets 24 and 25 and outlets 26 and 27 are provided on components 12 and 14 for circulation of heat transfer fluid through at least one passage in the body of each component.

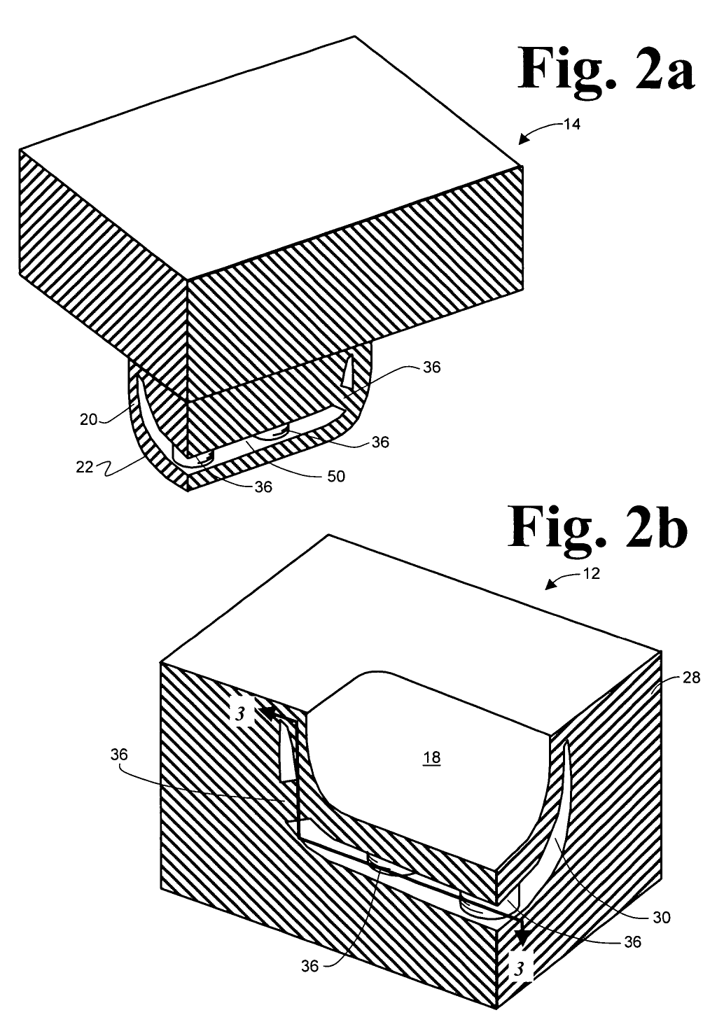

Referring to FIG. 2a, a partial cross section of core component 14 reveals internal passage 50 in the body of core element 20 through which heat transfer fluid is circulated. Passage 50 conforms substantially to one or more contours of molding surface 22 and comprises a roof and floor joined so as to define a cross section of passage 50 within the interior of the body of core component 14. Passage 50 is joined to inlet 25 and outlet 27 permitting a heat transfer fluid to flow from inlet 25 through passage 50 to outlet 27. Referring to FIGS. 2b and 4, a partial cross section of cavity component 12 reveals internal passage 30 in body 28 through which heat transfer fluid is circulated. Passage 30 comprises roof 32 spaced from and substantially conforming to one or more contours of molding surface 18 and floor 34 spaced from roof 32 so as to be located farther from molding surface 18 than is roof 32. Roof 32 and floor 34 are joined so as to define a cross section of passage 30 within the interior of the body of cavity component 12. Passage 30 is joined to inlet 24 and outlet 26 permitting a heat transfer fluid to flow from inlet 24 through passage 30 to outlet 26.

Variations of effectiveness of heat transfer are advantageously applied to affect flow and solidification of material within the cavity defined by mating mold components 12 and 14 in accordance with characteristics of the article to be molded and the molding tool. For example, heat transfer effectiveness may advantageously be varied to accommodate variations of thickness of the cavity cross section or proximity of regions of the cavity to boundaries of the mold component. Variations of effectiveness of heat transfer result from variation of the offset of the heat transfer conducting passage from the molding surface and variation of the rate of heat transfer to the heat transfer fluid. Variation of rates of heat transfer to the heat transfer fluid may result from variations of rates of flow through passage 30 as well as from turbulent flow of heat transfer fluid within passage 30. Referring to FIG. 4, a cross section of a portion of passage 30 illustrates flow of heat transfer fluid therethrough; the direction of flow being indicated by arrows 40 and turbulent flow being indicated by arrows 42. Variations of spacing (height “H”) of roof 32 from floor 34 effect variations of the area of the cross section of passage 30 producing localized variations in the rate of flow of heat transfer fluid through passage 30. Variations of offset “D” of roof 32 from molding surface 18 effect localized variations of the effective heat transfer from molding surface 18 to the heat transfer fluid. Where it is desired to effect turbulent flow, passage 30 advantageously includes artifacts providing localized variations of surface texture (not shown) of at least one of roof 32 and floor 34 or partial obstructions such as blocks 44 forcing diversion of heat transfer fluid there-around. Surface features that may be advantageously used to this effect include patterns of ridges and/or depressions as well as random variations of surface roughness. Partial obstructions inducing turbulent flow may include, for example, projections from surfaces of roof 32, floor 34 or support pillars 36. Further, such projections may include surface features to enhance creation of turbulent flow.

Heat transfer fluid conducting passages in accordance with the present invention substantially conform to contours of the molding surface. While heat transfer from the molding surface would advantageously be effected primarily by heat transfer fluid circulated through an open passage substantially surrounding the molding surface, an entirely open passage could result in relatively large areas of the molding surface having reduced structural support from the mold component body. Where forces during molding could result in flex of the molding surface in the event of inadequate structural support, support pillars are advantageously placed within passage 30. Referring to FIGS. 2 and 3, support pillars 36 are located within passage 30 and joined to roof 32 and floor 34. The number, size and location of support pillars 36 are chosen to provide adequate structural support to prevent unacceptable flex of molding surface 18 during molding. Although shown as substantially solid cylindrical pillars in FIGS. 2 and 3, support pillars 36 may be of any cross section and need not be solid, so long as the aforesaid support function is achieved by the placement, size and number of the support pillars employed. Support pillars 36 additionally function as obstructions within passage 30 effecting turbulent flow of heat transfer fluid therethrough. Pillars 36 provide conduction of heat between the molding surface and the pillar periphery in contact with the heat transfer fluid and exchange of heat thereat with the heat transfer fluid. Advantageously, design of the pillars may be adapted to provide localized variations of heat transfer effectiveness at the molding surface through the combination of conduction with the molding surface and exchange with the heat transfer fluid.

Although illustrated as applied only to cavity component 12, passages for conduction of heat transfer fluid in accordance with the invention may as well be applied to core component 14, or to both cavity component 12 and core component 14. When such passages are applied to core component 14, connections such as inlet 24 and outlet 26 would also be provided on core component 14. The selection of a mold component for circulation of heat transfer fluid is determined in accordance with the overall design of the molding tool, consideration being given to the preferred arrangement of points of injection of molding material and of devices, if any, for ejection of molded articles.

Mold tooling in accordance with the invention may be produced wherein each mating mold component comprises an assembly of sub-components defining passage 30, the molding surface of a mold component being advantageously defined by a single sub-component. Alternatively, mold tooling in accordance with the invention may be produced by processes using sacrificial cores, that is cores that are destroyed to produce internal open passages. Mold tooling in accordance with the invention is advantageously produced by a sequential layer deposition process whereby three-dimensional articles are built-up in thin layers, each layer of tooling material being deposited on a preceding layer. Suitable alternative deposition processes are known, including processes wherein a melt is deposited in sequential layers and processes wherein layers of metal powder are deposited on layers of binder. In the former, the melt is bonded to the preceding layer during deposition. In the latter, the metal powder is adhered to the preceding layer by curing the binder, the “green” metal powder article is sintered to volatize the binder and fuse the metal powder, and the sintered article is infiltrated with liquefied metal through capillary action to produce a finished article. The latter process is advantageously implemented by equipment that “prints” each layer of binder as small droplets providing a relatively high degree of precision in the pattern of metal powder of each layer.

What is claimed is:

1. A mold component of a molding tool, the mold component having a body, a molding surface thereon, and at least one passage internal to the body for conducting a heat transfer fluid from an inlet thereto to an outlet therefrom, wherein at least one of the area of the passage cross section and the offset distance of the passage from the molding surface varies between the inlet and outlet.

2. The mold component of claim 1 wherein the passage comprises a roof spaced from and located proximate to the molding surface, a floor spaced from the roof and located farther from the molding surface than the roof, the roof and floor being joined to define a cross section of the passage, and the roof extending within the mold body so as to substantially conform in size and shape to one or more contours of the molding surface.

3. The mold component of claim 1 wherein the passage comprises one or more surface features for inducing turbulent flow of the heat transfer fluid.

4. The mold component of claim 1 wherein the passage comprises at least one partial obstruction for inducing turbulent flow of the heat transfer fluid.

5. The mold component of claim 1 wherein the passage further comprises at least one support pillar between the roof and floor.

6. The mold component of claim 5 wherein at least one support pillar comprises a surface feature for inducing turbulent flow of the heat transfer fluid.

7. The mold component of claim 5 wherein at least one support pillar comprises a partial obstruction for inducing turbulent flow of the heat transfer fluid.

8. The mold component of claim 5 wherein the passage further comprises one or more support pillars therein effective to provide support to the molding surface so as to provide sufficient structural support to the molding surface to prevent unacceptable flex thereof during molding.

9. A mold component having a body, a molding surface thereon, and at least one passage internal to the body for conducting a heat transfer fluid from an inlet thereto to an outlet therefrom, the passage comprising a roof spaced from and located proximate to the molding surface, a floor spaced from the roof and located farther from the molding surface than the roof, the roof and floor being joined to define a cross section of the passage, and the roof extending within the mold body so as to substantially conform in size and shape to one or more contours of the molding surface, wherein at least one of the area of the passage cross section and the offset distance of the passage from the molding surface varies between the inlet and the outlet.

10. The mold component of claim 9 wherein the passage comprises at least one internal feature for inducing turbulent flow of the heat transfer fluid.

11. The mold component of claim 9 wherein the passage further comprises one or more support pillars therein effective to provide structural support to the molding surface to prevent unacceptable flex thereof during molding.

12. A method of molding an article comprising forcing flowable material to conform to molding surfaces of a mold cavity defined by a molding tool, allowing the flowable material to solidify and separating components of the molding tool to permit removal of the molded article, wherein the molding tool comprises at least one mold component having a body, a molding surface thereon, and at least one passage internal to the body for conducting a heat transfer fluid from an inlet thereto to an outlet therefrom, wherein at least one of the area of the passage cross section and the offset distance of the passage from the molding surface varies between the inlet and outlet.

13. The method of claim 11 wherein the passage of the molding tool comprises at least one internal feature for inducing turbulent flow of the heat transfer fluid.

14. The method of claim 13 wherein the passage comprises a surface feature for inducing turbulent flow of the heat transfer fluid.

15. The method of claim 13 wherein the passage comprises a partial obstruction for inducing turbulent flow of the heat transfer fluid.

16. The method according to claim 12 wherein the passage comprises a roof spaced from and located proximate to the molding surface, a floor spaced from the roof and located farther from the molding surface than the roof, the roof and floor being joined to define a cross section of the passage and wherein the roof extends within the mold body so as to substantially conform in size and shape to one or more contours of the molding surface.

17. The method of claim 16 wherein the passage of the molding tool comprises at least one support pillar between the roof and floor.

18. The method of claim 17 wherein the passage comprises at least one or more support pillars effective to provide support to the molding surface so as to sufficiently limit flex thereof during molding so as to produce molded articles of acceptable quality.

19. The method of claim 16 wherein at least one support pillar comprises a surface feature for inducing turbulent flow of the heat transfer fluid.

20. The method of claim 16 wherein at least one support pillar comprises a partial obstruction for inducing turbulent flow of the heat transfer fluid,
